(19) United States
(12) Patent Application Publication
(10) Pub. No.: US 2009/0280430 A1
(43) Pub. Date: Nov. 12, 2009

(54) Method for Manufacturing Toner

(76) Inventors: Hui Je Lee, Incheon (KR); Woo Cheul Jung, Ulsan (KR); Ji Hoon Lee, Daejeon (KR); Yu Na Kim, Daejeon (KR); Jung Woo Kim, Daejeon (KR)

Correspondence Address: MCKENNA LONG & ALDRIDGE LLP, 1900 K STREET, NW, WASHINGTON, DC, 20006, US

(21) Appl. No.: 12/226,065

(22) PCT Filed: Jan. 30, 2008
(86) PCT No.: PCT/KR2008/000565

§ 371 Date: Oct. 7, 2008

(30) Foreign Application Priority Data
Jan. 31, 2007 (KR) 10-2007-0010192

(51) Int. Cl. G03G 9/087; G03G 9/08

(52) U.S. Cl. 430/137.15

(57) ABSTRACT

There is provided a method for manufacturing a toner capable of providing a toner having excellent low-temperature fixing property and anti-offset property by adjusting a molecular weight distribution of a polymerization toner to a narrow distribution range. The method is characterized in that a toner is polymerized using a reversible addition-fragmentation chain transfer polymerization (RAFT) method by adding a dithioacetate, xanthate or dithioester-based chain transfer agent in the polymerization of a toner. The method for manufacturing a toner comprises: dissolving a dispersant in water to prepare an aqueous dispersion solution; mixing a binder resin monomer, a charge control agent, a pigment, a wax and a dithioacetate, xanthate or dithioester-based chain transfer agent to prepare a monomer mixture; adding the monomer mixture to the aqueous dispersion solution and suspension-polymerizing the monomer mixture to form a toner composition; removing the dispersant from the toner composition; and drying the dispersant-free toner composition under a vacuum condition.

### TECHNICAL FIELD

The present invention relates to a method for manufacturing a toner, and more particularly, to a method for manufacturing a toner having a narrow molecular weight distribution using a reversible addition-fragmentation chain transfer polymerization (RAFT) method.

### BACKGROUND ART

Recently, there is a suddenly increasing demand for an image forming apparatus such as a printer as a computer is generally used to make documents and the like, which leads to the sudden increase in the use of toner. Also, there has been an increasing demand for a toner that is able to display high-definition images and color images and to print a large amount of documents at a high speed and has low energy consumption.

Conventional methods for manufacturing a toner are mainly divided into two groups: a pulverization process and a polymerization process. Among them, the pulverization process means a method comprising: first synthesizing a binder resin using a chemical polymerization process, for example, emulsion, suspension, solution, bulk polymerization processes, etc.; adding additives, such as a pigment, a charge control agent, a wax and the like, to the synthesized binder resin; melt-mixing or extruding the resulting mixture; and mechanically pulverizing the melt-mixed or extruded mixture to manufacture a toner. When the toner is manufactured using the pulverization process, the manufacturing process is complicated and the energy consumption is high since the pulverization process includes steps of polymerizing a binder resin, melt-mixing additives with the polymerized binder resin and pulverizing the melt-mixed mixture. Also, problems regarding the charging characteristics or the transfer efficiency may be caused due to the irregular shapes, for example, wide grain size distribution and pointed edges, since the size of toner particles is controlled through the mechanical pulverization process. In addition, it is necessary to minimize the toner particles to a micrometer level so as to form a high-definition image. However, there is a limit to the minimization of the size of the toner particles when the toner is manufactured using the mechanical pulverization process.

Meanwhile, the polymerization process is a method for manufacturing toner particles by polymerizing a binder resin and additives without using the melt-mixing and mechanical pulverization processes. In this case, the polymerization process has an advantage that it is easy to minimize particles of toner and control the shape of toner.

The polymerization process is sub-divided into an emulsion polymerization process and a suspension polymerization process. Among them, the emulsion polymerization process means a method comprising: previously emulsifying additives such a pigment, a wax, a charge control agent and the like, dispersing the resulting emulsion in water together with monomers to polymerize toner particles. When the toner is manufactured through the emulsion polymerization process, it is advantageous in that it is possible to control the shape and size of the toner particles by adjusting the conditions such as polymerization temperature and polymerization time during the polymerization process. In this case, the emulsion polymerization process has, however, disadvantages that minute particles formed in the manufacture of toner may be hazardously introduced into human bodies, and it is difficult to remove surfactants used as an emulsifying agent.

On the contrary, the suspension polymerization process is a method for polymerizing a toner comprising: uniformly dissolving or dispersing monomers and various additives such as a pigment, a wax, a charge control agent and the like to prepare a monomer mixture and introducing the monomer mixture into an aqueous dispersion solution including a dispersant to give a shear force. In this case, the suspension polymerization process has advantages that the manufacturing process is simple, and it is possible to manufacture spherical toner particles having a diameter of about 6 to 10 μm, which is suitable for the toner particles.

As described above, the polymerization process has advantages over the pulverization process in that it is easy to control the size of toner particles and the manufacturing process of toner is simple.

However, the manufacture of the polymerized toner requires treatment at a high temperature of 150° C. or above so as to transfer and fix a toner, and therefore this method has problems that the energy consumption is high, and it is difficult to match the rapid copying and printing requirements due to the long heating time. In order to solve the above problems, it is, first of all, important to decrease a fixing temperature of toner. For this purpose, various methods have been attempted.

As a method for decreasing a fixing temperature of toner, there is a method for manufacturing a toner using low molecular weight monomers having a low glass transition temperature. The fixing temperature of the toner is proportional to the glass transition temperature of the binder resin in the toner, and therefore it is possible to decrease the fixing temperature of toner when the toner is manufactured with the low molecular weight binder resin having a low glass transition temperature. However, a blocking phenomenon may easily appear in the keeping of the toner and an off-set phenomenon may also be easily caused during the printing operation since the low molecular weight binder resin is easily aggregated.

In order to solve the above problems and satisfy both of the low-temperature fixing property and the anti-offset property, there is proposed a method for manufacturing a toner using combination of a low molecular weight component and a high molecular weight component. That is to say, the low molecular weight component is used to improve the low-temperature fixing property, and the high molecular weight component is used to prevent the decrease in the offset generation temperature. However, this method has problems that the low molecular weight component may aggravate the charging characteristics of toner, and the low molecular weight component may contaminate a carrier, a photoconductor, etc. when it is used for an extended time, and therefore it is difficult to obtain a clear image.

Meanwhile, Japanese Patent Nos. 2984907 and 2928910 disclose a method for manufacturing a toner having a narrow molecular weight distribution as an alternative method capable of improving all the low-temperature fixing property and anti-offset property of the toner. According to the above-mentioned inventions, it is possible to manufacture a toner composition having a narrow molecular weight distribution ranging from 1.3 to 3.5 when toner particles are produced with a chain transfer agent for certain radical polymerization. As a result, it was revealed that the toner having a narrow molecular weight distribution has all excellent low-temperature fixing property and anti-offset property when compared to the conventional toners since the toner having a narrow molecular weight distribution has a low fixing temperature and a high offset generation temperature.

However, the above-mentioned inventions have problems that it is difficult to adjust the molecular weight distribution of a toner composition to a narrow level since a toner is manufactured by the free radical polymerization reaction, and it is also difficult to manufacture a toner since the manufacturing method requires the solution polymerization process.

### DISCLOSURE OF INVENTION

### Technical Problem

The present invention has been made to solve the foregoing problems with the prior art, and therefore an aspect of the present invention is to provide a method for manufacturing a toner capable of preparing a toner having a advantage that the manufacturing process thereof is simple and all of excellent low-temperature fixing property and anti-offset property since the toner has a narrow molecular weight distribution.

### Technical Solution

In order to solve the above problems, the present inventors have made repeated attempts, and found that, when a chain transfer agent such as dithioacetate, xanthate or dithioester is added in the suspension polymerization and a toner composition is manufactured using the living free radical polymerization method, the resulting toner composition has a narrow molecular weight distribution of 1.0 to 2.0. Therefore, the present invention was completed on the basis of the facts.

The expression ‘living free radical polymerization (or, controlled free radical polymerization)’ means a polymerization method in which a free radical polymerization reaction is carried out with present of an end capping material that can temporally intercept an end of a growing polymer chain, the polymerization method being developed to solve the problems regarding the free radical polymerization reaction that it is difficult to control degree of polymerization, molecular weight distribution, or shapes, for example chain structures, of polymers. In this case, the end capping material refers to a material that functions to temporally prevent a chain termination reaction or a chain transfer reaction between growing polymers by intercepting an end of a chain. In this case, the end capping material is used in the polymerization process, it is possible to control the degree of polymerization, molecular weight distribution and molecular structure. Meanwhile, for the living free radical polymerization reaction, radicals intercepted by the end capping material are re-activated by light or chemical reactions, and then the polymerization continues to proceed. Therefore, the living free radical reaction shows a living property where a chain is at an active state by the reversible exchange reaction between an active polymer and an inert polymer.

The living free radical polymerization process is used to maintain a low steady-state concentration of radicals by means of the dynamic equilibrium between the active state and the inert state, and therefore it is possible to synthesize a polymer having a narrow molecular weight distribution of approximately 1.0 to 2.0.

Meanwhile, the living free radical polymerization reaction is mainly divided into an atom transfer radical polymerization (ATRP), a nitroxid-mediated polymerization (NMP), and a reversible addition-fragmentation chain transfer polymerization (RAFT). In the case of the atom transfer radical polymerization process, transition metals are used to activate an inert polymer, and therefore the polymerization method has merits such as swift response time and easy handling, but has a problem that it is difficult to separate transition metal ions in the process of purifying a polymer. Meanwhile, nitroxid-based materials are used as the chain end capping material in the nitroxid-mediated polymerization, and therefore the polymerization method has a merit that it is possible to effectively control a molecular weight distribution of toner, but has problems that its reaction rate is slow and it is difficult to apply to a variety of the fields due to the effects of the monomer structure.

Therefore, the reversible addition-fragmentation chain transfer polymerization (RAFT) process is used in the present invention to solve the above problems. The reversible addition-fragmentation chain transfer polymerization (RAFT) is a relatively recently developed method, and characterized in that dithioacetate, xanthate or dithioester-based chain transfer agents are used as the chain end capping material and chain ends are endowed with a living property through the reversible reaction in which the chain transfer agent is coupled/uncoupled to/from the chain end.

According to the present invention, a toner may be manufactured through the RAFT method by mixing a monomer mixture with the dithioacetate, xanthate or dithioester-based chain transfer agent, followed by carrying out the suspension polymerization. Since the RAFT method is a kind of living free radical reactions, it is possible to obtain a polymer having a narrow molecular weight distribution.

### BEST MODE FOR CARRYING OUT THE INVENTION

Hereinafter, the method for manufacturing a toner according to the present invention will be described in detail, as follows.

The method for manufacturing a toner according to the present invention includes: dissolving a dispersant in water to prepare an aqueous dispersion solution; mixing a binder resin monomer, a charge control agent, a pigment, a wax and a dithioacetate, xanthate or dithioester-based chain transfer agent to prepare a monomer mixture; adding the monomer mixture to the aqueous dispersion solution and suspension-polymerizing the monomer mixture by giving a shear force, thereby to form a toner composition; washing the toner composition with water and filtering the toner composition to remove the dispersant; and drying the dispersant-free toner composition under a vacuum condition.

(1) Step 1: Preparation of Aqueous Dispersion Solution

A dispersant is dissolved in distilled water to prepare an aqueous dispersion solution. At least one selected from the group consisting of an inorganic dispersant and a water-soluble organic dispersant may be used as the dispersant, and an anionic surfactant may be further added, if necessary.

In this case, the dispersant includes: at least one inorganic dispersant selected from the group consisting of calcium phosphate salt, magnesium salt, hydrophilic silica, hydrophobic silica and colloidal silica; or at least one water-soluble organic dispersant selected from the group consisting of at least one non-ionic polymeric dispersant selected from the group consisting of polyoxyethylene alkylether, polyoxyalkylene alkylphenolether, sorbitan fatty acid ester, polyoxyalkylene fatty acid ester, glycerine fatty acid ester, polyvinyl alcohol, alkyl cellulose and polyvinyl pyrrolidone and at least one ionic polymeric dispersant selected from the group consisting of polyacrylamide, polyvinylamine, polyvinylamine N-oxide, polyvinyl ammonium salt, polydialkyl-diaryl ammonium salt, polyacrylic acid, polystyrene sulfonic acid, polyacrylate, polysulfonate and polyaminoalkyl acrylate; and they may be used alone or in combinations thereof. And, a content of the dispersant preferably ranges from 0.01 to 10 parts by weight, based on 100 parts by weight of the total dispersion solution.

When the content of the dispersant is less than 0.01 parts by weight, the reaction stability may be easily weak in the suspension polymerization, whereas by-products (emulsion particles) are increasingly formed and toner particles are formed with a lower size than a desired toner particle size when the content of the dispersant exceeds 10 parts by weight.

Meanwhile, the anionic surfactant, which may be used herein, includes at least one selected from the group consisting of fatty acid salt, alkyl sulfate ester salt, alkylaryl alkyl sulfate ester salt, dialkyl sulfosuccinate, alkyl phosphate and the like, and a content of the anionic surfactant preferably ranges from 0.001 to 20 parts by weight, based on 100 parts by weight of the total dispersion solution. When the content of the anionic surfactant is less than 0.001 parts by weight, the reaction stability may be adversely affected in the suspension polymerization. On the contrary, when the content of the anionic surfactant exceeds 20 parts by weight, by-products (emulsion particles) are increasingly formed and toner particles are formed with a lower size than a desired toner particle size.

(2) Step 2: Preparation of Monomer Mixture

In this step, a binder resin monomer, a charge control agent, a pigment, a wax and a chain transfer agent are mixed to prepare a monomer mixture, which will be used later as a polymerization material.

First, an aromatic vinyl-based monomer, an acrylate-based monomer, a methacrylate-based monomer or a dien-based monomer is used alone or in combinations thereof, and stirred to prepare a binder resin monomer. A charge control agent, a pigment, a wax and a chain transfer agent are added to the resulting binder resin monomer and stirred to prepare a monomer mixture.

Meanwhile, a cross-linking agent is preferably further added to the monomer mixture. When the cross-linking agent is added to the monomer mixture to prepare a toner, the aggregation among the toner particles may be prevented, which leads to the improved preservation properties.

Meanwhile, the binder resin monomer, which may be used herein, includes an aromatic vinyl-based monomer, an acrylate-based monomer, a methacrylate-based monomer and a dien-based monomer, and they may be used alone or in combinations thereof, and acidic or basic olefin-based monomers may be also used optionally.

Meanwhile, among the binder resin monomer, the aromatic vinyl-based monomer includes styrene, monochlorostyrene, methylstyrene, dimethylstyrene and the like, and they may be used alone or in combinations thereof. In this case, a content of the aromatic vinyl-based monomer preferably ranges from 30 to 90 parts by weight, based on the total weight of the binder resin monomer mixture. This is for the purpose of adjusting a glass transition temperature of the polymerized toner. Generally, an offset phenomenon may be caused due to the very low glass transition temperature when the content of the aromatic vinyl-based monomer is less than 30 parts by weight, whereas the fixing property may be deteriorated due to the very high glass transition temperature when the content of the aromatic vinyl-based monomer exceeds 90 parts by weight.

The acrylate-based monomer includes methyl acrylate, ethyl acrylate, n-butyl acrylate, isobutyl acrylate, dodecyl acrylate, octyl acrylate, 2-ethylhexyl acrylate, phenyl acrylate and the like, the methacrylate-based monomer includes methyl methacrylate, ethyl methacrylate, n-butyl methacrylate, isobutyl methacrylate, dodecyl methacrylate, octyl methacrylate, 2-ethylhexyl methacrylate and the like, and the dien-based monomer includes butadiene, isoprene and the like. The acrylate-based, methacrylate-based or dien-based monomer may be used alone or in combinations thereof, and a content of the monomer preferably ranges from 5 to 70 parts by weight, based on the total weight of the binder resin monomer mixture. As described in the aromatic vinyl-based monomer, the content of the monomer is defined to adjust a glass transition temperature of toner to a suitable temperature level.

Meanwhile, the acidic olefin-based monomer includes α,β-ethylene compounds having a carboxyl group, and the basic olefin-based monomer includes methacrylic ester-based, methacrylamide-based, vinyl amine-based, diaryl amine-based monomers of aliphatic alcohols having an amine group or a quaternary ammonium group, and their ammonium salts, and they may be used alone or in combinations thereof. A content of the olefin-based monomer preferably ranges from 0.1 to 20 parts by weight, based on the total weight of the binder resin monomer mixture. The acidic olefin-based monomer and the basic olefin-based monomer are added to improve charging characteristics of a toner surface. In this case, when the content of the olefin-based monomers exceeds 20 parts by weight, the reaction stability may be deteriorated in the polymerization of toner, which leads to the aggregation of the toner particles.

The charge control agent includes at least one selected from the group consisting of: at least one cationic charge control agent selected from the group consisting of nigrosine-type dye, higher aliphatic metal salt, alkoxy amine, chelate, quaternary ammonium salt, alkylamide, a fluorinated active agent and metal salt of naphthalic acid; and at least one anionic charge control agent selected from the group consisting of chlorinated paraffin, chlorinated polyester, acid-containing polyester, sulfonyl amine of copper phthalocyanine, and sulfonic acid group-containing styrene-acrylic polymer, and they may be used alone or in combinations thereof. In this case, a content of the charge control agent preferably ranges from 0.01 to 20 parts by weight, based on the total weight of the monomer mixture. When the content of the charge control agent is less than 0.01 parts by weight, the toner does not have a sufficient charge density that is required for a printing process. On the contrary, the charge quantity may be rather deteriorated when the content of the charge control agent exceeds 20 parts by weight.

The pigment, which may be used herein, includes at least one selected from the group consisting of: at least one inorganic dye selected from the group consisting of metal powder-type, metal oxide-type, carbon-type, sulfide-type, chromium salt-type and perrocyanide-type dyes; and at least one organic dye selected from the group consisting of azo-type, acidic dye-type, basic dye-type, mordant dye-type, phthalocyanine-type, quinacridone-type and dioxane-type dyes. A content of the pigment preferably ranges from 1 to 20 parts by weight, based on the total weight of the monomer mixture. When the content of the pigment is less than 1 part by weight, it is impossible to realize desired colors to a sufficient extent, whereas the dispersion between the monomer and the pigment may be difficult when the content of the pigment exceeds 20 parts by weight.

Petroleum refining wax, natural wax, synthetic wax and the like may be used as the wax. The petroleum refining wax includes paraffin wax, microcrystalline wax, ceresin wax and the like, the natural wax includes carnauba wax and the like, and the synthetic wax includes polyethylene, polypropylene and the like, but the present invention is not particularly limited thereto. The waxes may be used alone or in combinations thereof, and a content of the wax preferably ranges from 0.01 to 30 parts by weight, based on 100 parts by weight of the total monomer mixture.

Meanwhile, a dithioacetate, xanthate or dithioester-based compound may be used as the chain transfer agent. Among them, it is particularly preferred to use the dithioester-based chain transfer agent represented by the following Formula 1:

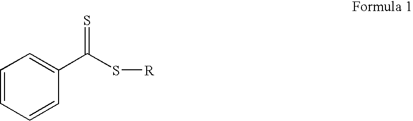

wherein, R represents a free radical leaving group including C1˜C10 linear or branched alkyl group, phenyl group, carboxy group and combinations thereof. Representative examples of the above-mentioned compound include benzyl dithiobenzoate, cumyl dithiobenzoate, 1-phenylethyl dithiobenzoate, S-(thiobenzoyl)thioglyicolic acid, etc.

Meanwhile, a content of the chain transfer agent preferably ranges from about 0.01 to 10 parts by weight, based on the total weight of the monomer mixture. When the content of the chain transfer agent is less than 0.01 parts by weight, it is impossible to effectively control the molecular weight distribution of toner, whereas the polymerization rate is very slow when the content of the chain transfer agent exceeds 10 parts by weight.

Meanwhile, the cross-linking agent, which may be used herein, includes divinylbenzene, ethylene dimethacrylate, ethylene glycoldimethacrylate, diethylene glycol, diacrylate, 1,6-hexamethylenediacrylate, allyl methacrylate, 1,1,1-trimethylol propane triacrylate, triallyl amine, etc. Here, a content of the cross-linking agent preferably ranges from 0.001 to 10 parts by weight, based on the total weight of the monomer mixture. When the content of the cross-linking agent is less than 0.001 parts by weight, it is difficult to expect the improvement of preservation properties. On the contrary, the fixing property of toner may be deteriorated in the printing process due to the gelation in an inner part of the toner when the content of the cross-linking agent exceeds 10 parts by weight.

(3) Step 3: Suspension Polymerization

A polymerization initiator is added to the monomer mixture prepared in the Step 2, and the monomer mixture is added to the aqueous dispersion solution prepared in the Step 1. A suspension polymerization process is carried out by applying a shear force to the aqueous dispersion solution including the monomer mixture.

As the polymerization initiator, an azo-based initiator such as bisisobutyronitrile and azobisdimethylvaleronitrile; an organic peroxide such as benzoyl peroxide and lauroyl peroxide; and a water-soluble initiator such as calcium persulfate and ammonium persulfate may be used. In this case a content of the polymerization initiator preferably ranges from 0.01 to 5 parts by weight, based on the total weight of the monomer mixture. Unreacted materials may be present when the content of the polymerization initiator is less than 0.01 parts by weight, whereas the reaction stability may be degraded due to the very swift response time when the content of the polymerization initiator exceeds 5 parts by weight.

(4) Step 4: Separation of Dispersant

When the polymerization process is completed, an aqueous basic solution or an aqueous acidic solution is added to the monomer mixture, depending on the kind of the dispersant, to remove the dispersant, and the dispersant-free monomer mixture is washed with water and filtered to separate the dispersant. For example, when colloidal silica is used as the aqueous dispersant, the colloidal silica may be separated by adding 0.05 to 0.2N NaOH to the monomer mixture. This step is repeated until the dispersant is completely separated from the toner.

(5) Step 5: Drying Process

When the dispersant is completely separated from the toner, the resulting toner particles are put into a vacuum oven, and dried at a room temperature for about 48 hours to obtain the final toner particles.

As in the method for manufacturing a toner according to the present invention, the polymerization reaction appear by means of the living free radical reaction when the dithioacetate, xanthate or dithioester-based chain transfer agent is added during the suspension polymerization. Then, a toner having a narrow molecular weight distribution of 1.0 to 2.0 is manufactured as a result of the living free radical polymerization. The expression ‘having a narrow molecular weight distribution’ means that a compound has monodispersity, or is near to the monodispersity. Therefore, monodispersed materials have excellent thermal reaction properties such as instant melting and solidification behavior.

According to the method of the present invention, it is possible to manufacture a toner having a narrow molecular weight distribution, excellent thermal reaction properties and a good fixing property. Also, the toner having a narrow molecular weight distribution has improved preservation properties, or improved electric stability such as uniformity of charge distribution or transfer efficiency.

### MODE FOR THE INVENTION

Hereinafter, exemplary embodiments of the present invention demonstrated that the toner manufactured according to the method of the present invention has a narrow molecular weight distribution, and therefore it was shown the toner according to the present invention is excellent in respect to the physical properties such as fixing temperature, offset generation temperature and transfer efficiency, compared to the toner manufactured according to the conventional method.

Therefore, the description proposed herein is just a preferable example for the purpose of illustrations only, not intended to limit the scope of the invention

### Example 1

15 g of colloidal silica were dissolved in 600 g of distilled water in a 1000 ml reactor, and heated to a reaction temperature of 70° C. to prepare an aqueous dispersion solution.

240 g of styrene, 54 g of butyl acrylate, 6 g of allyl methacrylate and 15 g of Carbon Black were added to another container, and stirred for 2 hours at a rotary speed of 2,000 rpm in a bead mill. Then beads were removed from the container to prepare 160 g of a monomer mixture. The resulting monomer mixture was warmed in water bath to a temperature of 70° C., and 1.5 g of a sulfonic acid group-containing styrene-acrylic polymeric charge control agent, 7.5 g of a paraffin wax, and 0.5 g of benzyl dithiobenzoate as a RAFT agent, were added to the monomer mixture and dissolved thoroughly for 20 minutes with stirring. 3 g of azobisisobutyronitrile as polymerization initiator, was added to the thoroughly dissolved monomer mixture, and stirred for 3 minutes to prepare a reactant.

The reactant was added to the aqueous dispersion solution, and continuously reacted while stirring at a rotary speed of 10,000 rpm for 20 minutes in a homogenizer. After 20 minutes, the suspension polymerization reaction was carried out with stirring the resulting product at a rotary speed of 500 rpm for 20 hours in a conventional stirrer. Then, the synthesized toner was washed with water and filtered, and the washing and filtering processes were repeated to remove the dispersant and the resulting toner composition was dried to prepare the final toner.

### Example 2

A toner was manufactured in the same manner as in Example 1, except that 1 g of benzyl dithiobenzoate was used as the RAFT agent.

### Example 3

A toner was manufactured in the same manner as in Example 1, except that 3 g of benzyl dithiobenzoate was used as the RAFT agent.

### Comparative Example 1

A toner was manufactured in the same manner as in Example 1, except that benzyl dithiobenzoate as the RAFT agent was not used herein.

### Comparative Example 2

Instead of using benzyl dithiobenzoate as the RAFT agent, 0.03 g of a generally used molecular weight control agent, n-dodecyl mercaptan, was used herein. The other steps of the experimental method were carried out in the same manner as in Example 1.

Measurement 1

Molecular weights, molecular weight distributions, melting temperatures, glass transition temperatures (Tg) of the toners prepared in the Examples 1 to 3 and the Comparative examples 1 and 2 were measured. The results are listed in the following Table 1.

1) The molecular weight and the molecular weight distribution were measured in an Optilab RI detector, using a gel permeation chromatography (GPC) method, under conditions: GPC-MALS (Water/Wyatt), column (Phenogel MXH & L), THF solvent, a flow rate of 1.0 ml/min.

2) The melting temperature was determined in a flow tester (CFT-500D, Shimadzu Corp.) by calculating a half of the difference in piston stroke values at a flow onset temperature and a flow termination temperature from a curve of temperature-piston strokes (sample efflux) under conditions: a nozzle with a diameter of 1 mm and a length of 1 mm, a load of 30 kg/cm² and an increasing temperature of 6° C./min, and measuring a temperature at the piston stroke value as a melting temperature.

3) The glass transition temperature (Tg) is obtained at an intersection point between a sloped line of an endothermic curve and a base line of a curve that is obtained by heating a sample from a temperature of −20° C. to 100° C. at a rate of 10° C./min by using a differential scanning calorimeter (DSC 2010, TA Instrument).

Table 1

TABLE 1

| | Mn | | | Melting temp. | |
|---|---|---|---|---|---|
| | (g/mol) | Mw (g/mol) | PDI | (° C.) | Tg (° C.) |
| Example 1 | 54100 | 145000 | 2.68 | 131 | 61 |
| Example 2 | 65400 | 121000 | 1.85 | 129 | 60 |
| Example 3 | 70700 | 104000 | 1.47 | 126 | 62 |
| Comparative | 47600 | 182000 | 3.82 | 134 | 60 |
| example 1 | | | | | |
| Comparative | 38500 | 136000 | 3.53 | 125 | 61 |
| example 2 | | | | | |

As listed in the Table 1, the toners of Examples 1 to 3, manufactured using the dithioester-based chain transfer agent as RAFT agent in the suspension polymerization, has a molecular weight distribution of 2.68 to 1.47, whereas the toners of Comparative examples 1 and 2 where the RAFT agent is not used has molecular weight distribution of 3.53 to 3.82. Therefore, it was revealed that the use of the RAFT agent makes it possible to manufacture a toner composition having a narrow molecular weight distribution.

Measurement 2

2 parts by weight of silica RY200S was add to toner prepared in the Examples 1 to 3 and the Comparative examples 1 and 2, mixed and surface-treated in a blender at a rotary speed of 3000 rpm for 3 minutes. Then, performances of the toners were evaluated using a hot roller installation apparatus into which a fixing part of a commercially available copying machine is modified. The results are listed in the following Table 2.

The toners were evaluated for the following physical properties, as follows.

1) Fixing Efficiency

The fixing efficiency of toner is calculated as a ratio of image density before/after a paper having a printed image is peeled with a tape. When the image density before the peeling with a tape represents before ID and the image density after the peeling with a tape represents after ID, the fixing efficiency is calculated, as follows.

Fixing efficiency(%)=(After ID/Before ID)×100

Here, the expression ‘peeling with tape’ refers to a series of operations of attaching an adhesive tape to an image-printed paper by applying the adhesive tape to a load, followed by peeling the adhesive tape from the paper at a constant rate. In this Experimental example, a Scotch tape (from 3M) was attached to an image-printed paper by applying a load of 5 kg to the Scotch tape, and the changes in the image density before/after the peeling process were measured using a Macbeth Densitometer (Macbeth, Model No. RD-918).

2) Minimum Fixing Temperature

Toner-transferred papers were passed through a fixing machine at a rate of 20 sheets/min while increasing a temperature of the fixing machine by 5° C. from 90° C. to 240° C., and the lowest temperature of the fixing machine, which shows more than 80% of fixing efficiency, was then measured as the minimum fixing temperature.

3) Offset Generation Temperature

Toner-transferred papers were passed through a fixing machine at a rate of 20 sheets/min while increasing a temperature of the fixing machine by 5° C. from 90° C. to 240° C., and the maximum temperature at which the papers are contaminated by the toner was measured as an offset generation temperature.

Table 2

TABLE 2

| | Fixing Efficiency | Mimum Fixing | Offset Generation |
|---|---|---|---|
| | (%) | Temp. (° C.) | Temp. (° C.) |
| Example 1 | 85 | 155 | 215 |
| Example 2 | 95 | 150 | 220 |
| Example 3 | 95 | 135 | 230 |
| Comparative | 80 | 165 | 200 |
| example 1 | | | |
| Comparative | 75 | 150 | 175 |
| example 2 | | | |

As listed in the Table 2, it was revealed that the toners of Examples 1 to 3, manufactured by adding a RAFT agent as the dithioester-based chain transfer agent in the suspension polymerization, has more excellent physical properties such as fixing efficiency, low-temperature fixing property and anti-offset property than the toners of Comparative examples 1 and 2 where the RAFT agent is not used, when the toners of Examples 1 to 3 are compared to the toners of Comparative examples 1 and 2.

### INDUSTRIAL APPLICABILITY

According to the present invention, a toner having a narrow molecular weight distribution of 1.0 to 2.0 may be manufactured using the living free radical polymerization process, and therefore the method according to the present invention may be useful to provide a toner having all excellent low-temperature fixing property and offset resistance.

Also, the method according to the present invention has advantages that the manufacturing process is simple, and it is possible to manufacture a toner that applies to a variety of the fields and has desired size and shape since the toner is manufactured using the combination of the conventional suspension polymerization method and a manner of further adding a dithioacetate, xanthate or dithioester-based chain transfer agent.

1. A method for manufacturing a toner, the method comprising: dissolving a dispersant in water to prepare an aqueous dispersion solution; mixing a binder resin monomer, a charge control agent, a pigment, a wax and a dithioacetate, xanthate or dithioester-based chain transfer agent to prepare a monomer mixture;
adding the monomer mixture to the aqueous dispersion solution and suspension-polymerizing the monomer mixture to form a toner composition;
removing the dispersant from the toner composition; and
drying the dispersant-free toner composition under a vacuum condition.

2. The method of claim 1, wherein the chain transfer agent is selected from the group consisting of benzyl dithiobenzoate, cumyl dithiobenzoate, 1-phenylethyl dithiobenzoate and S-(thiobenzoyl)thioglyicolic acid.

3. The method of claim 1, wherein a content of the chain transfer agent ranges from 0.01 to 10 parts by weight, based on the total weight of the monomer mixture.

4. The method of claim 1, wherein the toner has a molecular weight distribution of 1.0 to 2.0.

5. The method of claim 1, wherein the binder resin monomer is at least one selected from the group consisting of aromatic vinyl-based, acrylate-based, methacrylate-based, dien-based, acidic olefin-based and basic olefin-based monomers.

6. The method of claim 1, wherein the charge control agent is at least one selected from the group consisting of at least one cationic charge control agent selected from the group consisting of at least one nigrosine-type dye, higher aliphatic metal salt, alkoxy amine, chelate, quaternary ammonium salt, alkylamide, a fluorinated active agent, and metal salts of naphthalic acid; and at least one anionic charge control agent selected from the group consisting of chlorinated paraffin, chlorinated polyester, acid-containing polyester, sulfonyl amine of copper phthalocyanine, and sulfonic acid group-containing styrene-acrylic polymers, and a content of the charge control agent ranges from 0.01 to 20 parts by weight, based on the total weight of the monomer mixture.

7. The method of claim 1, wherein the pigment is at least one selected from the group consisting of at least one inorganic dye selected from the group consisting of metal powder-type, metal oxide-type, carbon-type, sulfide-type, chromium salt-type and perrocyanide-type dyes; and at least one organic dye selected from the group consisting of azo-type, acidic dye-type, basic dye-type, mordant dye-type, phthalocyanine, quinacridone-type and dioxane-type dye, and a content of the pigment ranges from 1 to 20 parts by weight, based on the total weight of the monomer mixture.

8. The method of claim 1, wherein the dispersant is at least one selected from the group consisting of: at least one inorganic dispersant selected from the group consisting of calcium phosphate salt, magnesium salt, hydrophilic silica, hydrophobic silica and colloidal silica; and
at least one water-soluble polymeric dispersant selected from the group consisting of at least one non-ionic polymeric dispersant selected from the group consisting of polyoxyethylene alkylether, polyoxyalkylene alkylphenolether, sorbitan fatty acid ester, polyoxyalkylene fatty acid ester, glycerine fatty acid ester, polyvinyl alcohol, alkyl cellulose and polyvinyl pyrrolidone and at least one ionic polymeric dispersant selected from the group consisting of polyacrylamide, polyvinylamine, polyvinylamine N-oxide, polyvinyl ammonium salt, polydialkyl-diaryl ammonium salt, polyacrylic acid, polystyrene sulfonic acid, polyacrylate, polysulfonate and polyaminoalkyl acrylate;
and a content of the dispersant ranges from 0.01 to 10 parts by weight, based on 100 parts by weight of the entire dispersion solution.

9. The method of claim 1, wherein the wax is at least one selected from the group consisting of at least one petroleum refining wax selected from the group consisting of paraffin wax, microcrystalline wax and ceresin wax; a natural wax such as carnauba wax; and at least one synthetic wax selected from the group consisting of polyethylene and polypropylene, and a content of the wax ranges from 0.01 to 30 parts by weight, based on the total weight of the monomer mixture.
